(19) United States
(12) Patent Application Publication
(10) Pub. No.: US 2008/0049182 A1
(43) Pub. Date: Feb. 28, 2008

(54) LIQUID CRYSTAL DISPLAY PANEL

(76) Inventors: Shinichi Kawabe, Yokohama (JP); Takao Tanaka, Yachimata (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/675,717

(22) Filed: Feb. 16, 2007

(30) Foreign Application Priority Data
Mar. 14, 2006 (JP) 2006-068836

(51) Int. Cl. G02F 1/1339

(52) U.S. Cl. 349/156

(57) ABSTRACT

A liquid crystal display panel has pixel electrodes, pixel circuits which drive the pixel electrodes, video signal lines which supply video signals to the pixel circuits, control signal lines which supply control signals to the pixel circuits, on one of a pair of substrates sandwiching a liquid crystal material therebetween. Color resists associated with the pixel electrodes are disposed on another of the substrates, and a black matrix is disposed on the inner surface of the another substrate. Bead spacers are disposed between the two substrates. The pixel circuits, video signal lines, control signal lines and bead spacers are disposed to face the black matrix. Openings or cuts are provided in portions of regions of the color resists overlapping the black matrix and facing the pixel circuits.

### CLAIM OF PRIORITY

The present application claims priority from Japanese application serial no. 2006-068836, filed on Mar. 14, 2006, the content of which is hereby incorporated by reference into this application.

### BACKGROUND OF THE INVENTION

The present invention relates to a liquid crystal display panel display device.

First, a structure of a conventional liquid crystal display panel employing bead spacers will be explained by reference to FIGS. 2A and 2B.

A liquid crystal display panel 9 has a structure in which a liquid crystal material 5 is sandwiched between a TFT (Thin Film Transistor) substrate 1a having transistors formed thereon and a CF (Color Filter) substrate 1b having color filters of red, blue and green formed thereon, and the substrates 1a and 1b are fixed together by using a sealing member (not shown) disposed at their peripheries.

FIG. 2A is a perspective view of the liquid crystal display panel 9 with the TFT substrate 1a removed, and FIG. 2B is a cross-sectional view of the liquid crystal display panel 9 of FIG. 2A taken along line IIB-IIB of FIG. 2A. In the liquid crystal display panel 9, the spacing (hereinafter called the cell gap) 10 between the two substrates 1a and 1b into which the liquid crystal material 5 is sealed is an important determining factor in display quality. Especially, important are the absolute magnitude of the cell gap 10 and the uniformity of the cell gap 10 over the entire area of the liquid crystal display panel 9. Therefore, for the purpose of maintaining the spacing between the two substrates 1a, 1b at a fixed value in the liquid crystal display panel 9 of the above-explained structure, as shown in FIGS. 2A and 2B, usually transparent spherical particle spacers (hereinafter called bead spacers) 3 made of glass or synthetic resin and uniform in particle diameter are sprayed onto an inner surface of the substrate 1a or 1b before the substrates 1a and 1b are sealed together.

In the case of the liquid crystal display panel of the type in which the bead spacers 3 are sprayed onto the substrate 1a or 1b in fabrication of the liquid crystal display panel, since the assembling of the liquid crystal display panel is performed after a large number of the bead spacers 3 are sprayed onto the substrate 1a or 1b, some of the sprayed bead spacers 3 spill from the substrate during the operation of fabrication, and contaminate the manufacturing line, resulting in causes of defective products. Also in the case of the completed liquid crystal display panel of the type employing the bead spacers 3, when some of the bead spacers 3 are present in the liquid crystal material within display pixels, the liquid crystal material is absent in spaces occupied by the bead spacers 3, and as a result, the desired polarization of light cannot be obtained in the spaces occupied by the bead spacers 3. Consequently, for example, in a case in which transparent particles are used as the bead spacers 3, when the liquid crystal display panel is operated to display a black scene, the spaces occupied by the bead spacers 3 pass light therethrough and produce bright spots against the black scene. Further, the orientations of the liquid crystal molecules are disturbed in the vicinities of the bead spacers 3, as a result leakage of light occur in the vicinities of the bead spacers 3, and consequently, there arises a problem in that the display contrast ratio of the liquid crystal display panel is lowered and therefore the display quality is degraded. Reference numerals 14 and 15 in FIGS. 2A and 2B denote pixel sections and a black matrix, respectively.

To solve the above-explained problem, a method has been proposed and utilized which uses columnar spacers instead of the bead spacers 3. FIGS. 3A and 3B are a perspective view and a cross-sectional view illustrating a structure of a conventional liquid crystal display panel of this type, respectively.

FIG. 3A is a perspective view of the liquid crystal display panel 9 with a TFT substrate 1a removed, and FIG. 3B is a cross-sectional view of the liquid crystal display panel 9 of FIG. 3A taken along line IIIB-IIIB of FIG. 3A. As shown in FIGS. 3A and 3B, columnar spacers (hereinafter called photospacers) 4 are disposed in non-display areas 15 (opaque areas which are coated black and are hereinafter called BM (Black Matrix)) between pixel sections 14 on the CF substrate 1b. Usually the photospacers 4 are fabricated as follows:

First, a photosensitive resin intended for the spacers is coated on the substrate while adjusting to obtain a desired thickness as by a spin-coat method, a slit-coat method by using a rectangular nozzle, or a printing method.

Next, the coated photosensitive resin is exposed through a photomask configured such that portions of the resin corresponding to the spacers form protrusions on the substrate, by using a light source for exposure.

Then, the spacers protruding from the substrate are completed by subjecting the photosensitive resin to a developing process, thereafter removing the photosensitive resins coated in portions not intended for the spacers, then washing off the developing solutions adhering to the substrate, and then drying the substrate.

The photospacers fabricated by using the above method are capable of being disposed at arbitrary positions in the BM 15 regions between the pixel sections, which do not influence the display quality. Consequently, while in the case of the bead spacers, there has been a problem in that display quality is degraded due to light leakage through the bead spacers, in the case of the photospacers, the degradation in display quality can be prevented.

Further, for the above-mentioned reason, studies of techniques have been started which position the bead spacers at intended positions with precision in the BM regions between pixel sections which do not influence display quality, by using an ink jet method or a printing method.

The following will explain a method of positioning the bead spacers at intended positions with precision by using an ink jet method.

Usually, ink containing bead spacers is coated on the TFT substrate or the CF substrate, or both of them via an ink jet head. FIG. 4A is a plan view for explaining a relationship between one glass substrate 1 and an ink jet head 16 in a case in which two TFT substrates or two CF substrates intended for two liquid crystal display panels are fabricated from the one substrate 1, and FIG. 4B is an enlarged view of a portion A of the glass substrate 1. FIG. 5 is cross-sectional views illustrating a manufacturing process for positioning the bead spacers 3 at intended positions with precision by using an ink jet method. FIG. 5 illustrates the sequential steps for coating ink 6 containing the bead spacers 3 on the glass substrate 1 via an ink jet head 16. The coated droplet of the ink 6 contains the bead spacers 3 therein.

The droplet of the ink 6 coated on the substrate 1 evaporates in a step of drying the substrate 1, and therefore, only the bead spacers 3 remain at or in the vicinities of a place where the droplet of the ink 6 has landed. Consequently, as shown in FIG. 4A and FIG. 4B illustrating the enlarged detailed view of the portion A of FIG. 4A, it is possible to position the spacers 3 at intended positions with precision by controlling the landing positions of the droplets of the ink 6 so as to be within the BM 15 regions between the pixels 14R, 14G, 14B, which do not influence the display quality.

Greater detail of bead spacers and an ink jet system therefor is contained in U.S. Pat. No. 6,501,527 B1, the disclosure of which is herein incorporated by reference.

Interconnection lines and pixel circuits (TFT elements) are formed in portions of an inner surface of the TFT substrate 1a corresponding to the BM 15 regions, the non-display areas, between the pixels 14 on the CF substrate 1b. FIG. 6A is a plan view of a substrate 1 including two usual TFT substrates 1a for the liquid crystal display panel, and FIG. 6B is an enlarged detailed view of a portion A of FIG. 6A.

Disposed in a matrix fashion on an inner surface of the TFT substrate 1a are a plurality of sub-pixels each provided with a pixel electrode 500 (Usually three sub-pixels 14R, 14G and 14B displaying three primary colors of red (R), green (G) and blue (B), respectively, constitute one pixel).

In each of the sub-pixels 14R, 14G and 14B, a pixel circuit 11 is formed for driving a corresponding one of the sub-pixels 14R, 14G and 14B. Further, as shown in FIG. 6B, arranged in a horizontal direction on the inner surface of the TFT substrate 1a are a plurality of video signal lines extending in a vertical direction and supplying video signals to the pixel circuits 11, and arranged in the vertical direction on the inner surface of the TFT substrate 1a are a plurality of control signal lines extending in the horizontal direction and supplying control signals to the pixel circuits 11.

In this specification, video signal lines, control signal lines and the like are hereinafter collectively called interconnection lines or electrode lines.

The type of the pixel circuits 11 differs from the use of liquid crystal display panels. Widely used as the pixel circuit of liquid crystal display panels among others are a-Si (Amorphous-Silicon) TFTs of the inverted-staggered type shown in FIG. 7.

As shown in FIG. 7, initially a gate electrode 110 is formed on the TFT substrate 1a made of glass, and then a gate insulating film 120 is formed on the gate electrode 110 to cover the gate electrode 110. Then an amorphous silicon (a-Si) layer 130 is formed on a portion of the gate insulating film 120 over which the pixel circuit 11 is to be formed, and thereafter an etching-proof film 140 is formed on the amorphous silicon (a-Si) layer 130. Further, after n⁺ a-Si layers 150 are formed on positions where a source electrode 160 and a drain electrode 170 are to be formed subsequently, respectively, the source electrode 160 and the drain electrode 170 are formed. Then a passivation (PAS) film 180 is formed to cover the approximately entire region over the glass substrate 1a.

Since the above-mentioned a-Si TFT circuit of the inverted-staggered type comprises a stack of electrode lines and insulating films, as shown in FIG. 7, there is a difference H in height between a non-pixel-circuit-forming region 200 where the pixel circuit 11 is not formed and a pixel-circuit-forming region 300 where the pixel circuit is formed. An example of values of the difference H is in a range of from 600 nm to 700 nm.

The BM 15 regions between pixels 14 of the CF substrate 1b oppose the electrode lines 12 which have the pixel circuits 11 thereon overlapping with portions thereof on the TFT substrate 1a. Therefore, in a case where the bead spacers 3 are disposed at intended positions with precision in the BM 15 regions of the CF substrate 1b, or in a case where the bead spacers 3 are disposed at intended positions with precision on the electrode line 12 of the TFT substrate 1a, it is necessary to position the bead spacers 3 at positions clear of the regions of the pixel circuits 11 with precision, for the purpose of avoiding the influences of the above-explained difference H in height. If some of the bead spacers 3 are disposed by chance at the regions of the pixel circuits 11, the cell gaps only at the regions of the pixel circuits 11 will be established to be larger than those in the remaining portions in the assembled liquid crystal display panel. Further, in this case, there is a possibility that excessive force may be exerted on the pixel circuits 11, and as a result, characteristics of the pixel circuits 11 may change, and in the worst case the pixel circuits 11 may be destroyed.

As shown in FIG. 4A and FIG. 4B which is the enlarged detailed view of the portion A of FIG. 4A, the red sub-pixels 14R, the blue sub-pixels 14B and the green sub-pixels 14G are arranged evenly with a horizontal pitch Gx and a vertical pitch Gy on the CF substrate 1b and the TFT substrate 1a. The pitches Gx, Gy of the sub-pixels are determined necessarily by the size of a liquid crystal display panel and a resolution required of the liquid crystal display panel, and they vary from product type to product type and also vary from manufacturer to manufacturer.

As explained above, the pixel circuits 11 are arranged with the horizontal sub-pixel pitch Gx and the vertical sub-pixel pitch Gy on the TFT substrate 1a, and therefore, for the purpose of positioning the bead spacers 3 at positions clear of the regions of the pixel circuits 11, ideally it is desired that the following relationship is satisfied between the sub-pixel pitches Gx, Gy and the pitches Px, Py with which the bead spacers 3 are to be positioned with precision.
Gx=Px (or Gx=nPx),
Gy=Py (or Gy=nPy),

where n is a natural number.

The ink jet head 16 used for the ink jet method is usually provided with a plurality of nozzles evenly arranged for discharging the droplets of the ink 6 as shown in FIG. 4A. In a case where the above-explained ink jet head 16 is used for positioning the ink 6 containing the bead spacers 3 at intended positions with precision, the ink 6 is usually dropped onto the substrate 1 with a desired pitch Py by discharging the ink 6 every time the ink jet head 16 or the substrate 1 is moved by a fixed distance equal to the sub-pixel pitch Gy.

Therefore, the pitch Py in the direction of the movement of the ink jet head 16 or the substrate 1 can usually be adjusted to an arbitrary value by adjusting the amount of the movement of the ink jet head 16 or the substrate 1 and the timing of discharging of the ink 6 from the ink jet head 16. On the other hand, since the pitch Px of the nozzles is determined by the nozzle pitch of the employed ink jet head, the pitch Px is fixed. For making the discharging pitch Px of the ink droplets equal to the pitch Gx of arrangement of the sub-pixels, it is necessary to prepare an ink jet head having the same nozzle pitch Px as the sub-pixel pitch Gx of liquid crystal display panels to be manufactured. However, it is usual for one production line for liquid crystal display panels to manufacture liquid crystal display panels of various sizes and various resolutions, and therefore the fact is that it is very difficult to make the nozzle pitch Px of the ink jet head equal to the sub-pixel pitch Gx of liquid crystal display panels to be manufactured. Consequently, little significant progress has been made in application to volume production of the method of positioning bead spacers at intended positions with precision by using the ink jet method.

Japanese Patent Application Laid-Open No. 2001-083524 discloses a technique of forming spacers by depositing bead-containing spacer-forming materials comprised of beads dispersed in an adhesive onto selected portions of regions overlying a black matrix by using an ink jet head, and thereafter curing the adhesive.

Japanese Patent Application Laid-Open No. 2001-083906 discloses a technique of forming spacers by depositing adhesives onto selected portions of regions overlying a black matrix by using an ink jet head, then scattering beads on the substrate and removing beads of the scattered beads not adhering to the adhesives, and fixing the remaining beads to the substrate by curing the adhesives.

Japanese Patent Application Laid-Open No. 2001-249342 discloses a technique of transferring spacer beads to positions which do not deteriorate display contrast ratio on a substrate by transferring to the positions the spacer beads stuck onto tips of soft protrusions formed integrally on a plate made of rubber or the like.

Japanese Patent Application Laid-Open No. 2002-372717 discloses a technique of disposing bead spacers on vertically-extending signal lines and/or horizontally-extending signal lines on a substrate by using an ink jet method.

### SUMMARY OF THE INVENTION

For the purpose of establishing the desired thickness of a liquid crystal layer sealed between a pair of substrates, mainly used in the case of conventional liquid crystal display panels is a method of using substrates having spherical bead spacers sprayed over an entire surface thereof, or a method of using substrates provided with columnar spacers having been formed of a photosensitive resin beforehand in regions between pixel sections on the substrates not adversely affecting display quality by using a photolithographic technique.

However, recently a technique has been studied which positions bead spacers at intended positions with precision in regions between pixel sections which do not influence display quality, by using an ink jet method.

In a case in which bead spacers are positioned at intended positions with precision by using an ink jet method and employing one ink jet head provided with a plurality of nozzles for discharging ink solutions, it is difficult to use the one ink jet head for manufacturing liquid crystal display panels of various kinds having different pixel pitches. Consequently, there was no alternative but to choose from among the following:

(1) provision of a plurality of ink jet heads each having ink-solution-discharge nozzles arranged with a pith equal to that of sub-pixels of respective liquid crystal display panels;

(2) adjusting of effective pitches of ink-solution-discharge nozzles by angularly displacing an angle between the direction of arrangement of ink-solution-discharge nozzles of an ink jet head and the direction of movement of the ink jet head or the direction of movement of a substrate from 90 degrees in the case illustrated in FIG. 8A to an angle other than 90 degrees in the case illustrated in FIG. 8B; and

(3) carrying out an ink jet method ignoring a difference between the pitch of ink-solution-discharge nozzles and that of sub-pixels of the liquid crystal display panel.

In view of the above, it is an object of the present invention to provide a configuration of a substrate capable of preventing changes in characteristics of pixel circuits and destruction of the pixel circuits which are caused by variations which might otherwise have occurred in a cell gap between a TFT substrate and a CF substrate or excessive forces might otherwise have been exerted on the pixel circuits by bead spacers, even in a case in which a liquid crystal display panel has been assembled with the bead spacers being disposed on the pixel circuits by chance because the pitch of arrangement of ink-solution-discharge nozzles of an ink jet head is not equal to the pitch of sub-pixels of the liquid crystal display panel. And it is another object of the present invention to provide a method of fabricating the above substrate.

The following will explain the summary of the representative ones of the inventions disclosed in this specification.

(1) A liquid crystal display panel comprising: a pair of substrates; a liquid crystal material sandwiched between said pair of substrates; a plurality of pixel electrodes disposed in a matrix on an inner surface of one of said pair of substrates; a plurality of pixel circuits, each of said plurality of pixel circuits being disposed in a vicinity of a corresponding one of said plurality of pixel electrodes and driving said corresponding one of said plurality of pixel electrodes; a plurality of video signal lines disposed on said inner surface of said one of said pair of substrates and supplying video signals to said plurality of pixel circuits; a plurality of control signal lines disposed on said inner surface of said one of said pair of substrates and supplying control signals to said plurality of pixel circuits; a plurality of color resists disposed on an inner surface of another of said pair of substrates and constituting primary-color filters each associated with a corresponding one of said plurality of pixel electrodes; a black matrix comprised of a light-blocking material, disposed on said inner surface of said another of said pair of substrates, and defining an area useful for display of each of said plurality of color resists; and a plurality of bead spacers disposed between said pair of substrates and establishing a spacing between said pair of substrates, wherein: said plurality of pixel circuits, said plurality of video signal lines and said plurality of control signal lines are disposed to face said black matrix; said plurality of bead spacers are disposed to face said black matrix; and openings or cuts are provided in portions of regions of said plurality of color resists overlapping said black matrix and facing said plurality of pixel circuits.

(2) The liquid crystal display panel according to (1), wherein, in regions of said inner surface of said one of said pair of substrates facing said plurality of bead spacers, a height h of a step produced by said openings or cuts is greater than a height H of a step produced by said plurality of pixel circuits with respect to regions where said plurality of video signal lines or said plurality of control signal lines are disposed.

(3) A liquid crystal display panel comprising: a pair of substrates; a liquid crystal material sandwiched between said pair of substrates; a plurality of pixel electrodes disposed in a matrix on an inner surface of one of said pair of substrates; a plurality of pixel circuits, each of said plurality of pixel circuits being disposed in a vicinity of a corresponding one of said plurality of pixel electrodes and driving said corresponding one of said plurality of pixel electrodes; a plurality of video signal lines disposed on said inner surface of said one of said pair of substrates and supplying video signals to said plurality of pixel circuits; a plurality of control signal lines disposed on said inner surface of said one of said pair of substrates and supplying control signals to said plurality of pixel circuits; a plurality of color filters disposed on an inner surface of another of said pair of substrates and each associated with a corresponding one of said plurality of pixel electrodes; a black matrix comprised of a light-blocking material, disposed on said inner surface of said another of said pair of substrates, and defining an area useful for display of each of said plurality of color filers; an overcoat film covering said plurality of color filters; and a plurality of bead spacers disposed between said pair of substrates and establishing a spacing between said pair of substrates, wherein: said plurality of pixel circuits, said plurality of video signal lines and said plurality of control signal lines are disposed to face said black matrix; said plurality of bead spacers are disposed to face said black matrix; and openings are provided in regions of said overcoat film facing said plurality of pixel circuits.

(4) The liquid crystal display panel according to (3), wherein, in regions of said inner surface of said one of said pair of substrates facing said plurality of bead spacers, a height hoc of a step produced by said openings in said overcoat film is greater than a height H of a step produced by said plurality of pixel circuits with respect to regions where said plurality of video signal lines or said plurality of control signal lines are disposed.

(5) A liquid crystal display panel comprising: a pair of substrates; a liquid crystal material sandwiched between said pair of substrates; a plurality of pixel electrodes disposed in a matrix on an inner surface of one of said pair of substrates; a plurality of pixel circuits, each of said plurality of pixel circuits being disposed in a vicinity of a corresponding one of said plurality of pixel electrodes and driving said corresponding one of said plurality of pixel electrodes; a plurality of video signal lines disposed on said inner surface of said one of said pair of substrates and supplying video signals to said plurality of pixel circuits; a plurality of control signal lines disposed on said inner surface of said one of said pair of substrates and supplying control signals to said plurality of pixel circuits; a plurality of color filters disposed on an inner surface of another of said pair of substrates and each associated with a corresponding one of said plurality of pixel electrodes; a black matrix comprised of a light-blocking material, disposed on said inner surface of said another of said pair of substrates, and defining an area useful for display of each of said plurality of color filers; and a plurality of bead spacers disposed between said pair of substrates and establishing a spacing between said pair of substrates, wherein: said plurality of pixel circuits, said plurality of video signal lines and said plurality of control signal lines are disposed to face said black matrix; said plurality of bead spacers are disposed to face said black matrix; and pedestals are provided in regions of said inner surface of said another of said pair of substrates which face said plurality of bead spacers, and which do not face said plurality of pixel circuits.

(6) The liquid crystal display panel according to (5), wherein a height of said pedestals is greater than a height H of a step produced by said plurality of pixel circuits in regions of said inner surface of said one of said pair of substrates facing said plurality of bead spacers, said height H being measured with respect to regions where said plurality of video signal lines or said plurality of control signal lines are disposed.

(7) A liquid crystal display panel comprising: a pair of substrates; a liquid crystal material sandwiched between said pair of substrates; a plurality of pixel electrodes disposed in a matrix on an inner surface of one of said pair of substrates; a plurality of pixel circuits, each of said plurality of pixel circuits being disposed in a vicinity of a corresponding one of said plurality of pixel electrodes and driving said corresponding one of said plurality of pixel electrodes; a plurality of video signal lines disposed on said inner surface of said one of said pair of substrates and supplying video signals to said plurality of pixel circuits; a plurality of control signal lines disposed on said inner surface of said one of said pair of substrates and supplying control signals to said plurality of pixel circuits; a plurality of color filters disposed on an inner surface of another of said pair of substrates and each associated with a corresponding one of said plurality of pixel electrodes; a black matrix comprised of a light-blocking material, disposed on said inner surface of said another of said pair of substrates, and defining an area useful for display of each of said plurality of color filers; and a plurality of bead spacers disposed between said pair of substrates and establishing a spacing between said pair of substrates, wherein: said plurality of pixel circuits, said plurality of video signal lines and said plurality of control signal lines are disposed to face said black matrix; said plurality of bead spacers are disposed to face said black matrix; and pedestals are provided in regions of said inner surface of said another of said pair of substrates which face said plurality of bead spacers, and in which said plurality of pixel circuits are not disposed.

(8) The liquid crystal display panel according to (7), wherein a height of said pedestals is greater than a height H of a step produced by said plurality of pixel circuits in regions of said inner surface of said one of said pair of substrates facing said plurality of bead spacers, said height H being measured with respect to regions where said plurality of video signal lines or said plurality of control signal lines are disposed.

The implementation of the present invention makes it possible to prevent changes in characteristics of pixel circuits and destruction of the pixel circuits which are caused by bead spacers disposed on pixel circuits. In this case, it is also possible to prevent occurrences of variations in cell gap between a TFT substrate and a CF substrate.

Further, the present invention has eliminated the need for making the pitch of ink solution deposition equal to the pitch of sub-pixels of a liquid crystal display panel by selecting the pitch of ink-solution-discharge nozzles of an ink jet head to be equal to the pitch of the sub-pixels, so as to prevent bead spacers from being deposited on the pixel circuits.

Further, with the present invention, even in a case in which the ink-jet-type bead-spacer deposition equipment is provided with an ink jet head having only one kind of the pitch of ink-solution-discharge nozzles, the ink-jet-type bead-spacer deposition equipment is compatible with various liquid crystal display panels having various kinds of sub-pixel pitches.

### BRIEF DESCRIPTION OF THE DRAWINGS

In the accompanying drawings, in which like reference numerals designate similar components throughout the figures, and in which:

FIG. 1A is a plan view of a substrate 1 including two CF substrates 1b for liquid crystal display panels in accordance with Embodiment 1 of the present invention;

FIG. 1B is an enlarged detailed view of a portion A of FIG. 1A;

FIG. 1C is a cross-sectional view of the CF substrate 1b of FIG. 1B taken along line IC-IC of FIG. 1B;

FIG. 1D is a cross-sectional view of the CF substrate 1b of FIG. 1B taken along line ID-ID of FIG. 1B;

FIG. 1E is a cross-sectional view of the CF substrate 1b of FIG. 1B taken along line IE-IE of FIG. 1B;

FIG. 1F is a cross-sectional view of the CF substrate 1b of FIG. 1B taken along line IF-IF of FIG. 1B;

FIG. 1G is a cross-sectional view of a liquid crystal display panel fabricated by using the CF substrate 1b in accordance with Embodiment 1;

FIG. 2A is a perspective view of a conventional liquid crystal display panel employing bead spacers with a TFT substrate removed;

FIG. 2B is a cross-sectional view of the liquid crystal display panel of FIG. 2A taken along line IIB-IIB of FIG. 2A;

FIG. 3A is a perspective view of a conventional liquid crystal display panel employing columnar spacers with a TFT substrate 1a removed;

FIG. 3B is a cross-sectional view of the liquid crystal display panel of FIG. 3A taken along line IIIB-IIIB of FIG. 3A;

FIG. 4A is a plan view of a CF substrate for explaining a condition for positioning bead spacers at intended positions with precision by using an ink jet method in a case in which two TFT substrates or two CF substrates intended for two liquid crystal display panels are fabricated from one substrate;

FIG. 4B is an enlarged detailed view of a portion A of the substrate of FIG. 4A;

FIG. 5 is schematic cross-sectional views illustrating states in drying process of a droplet of ink containing bead spacers in a manufacturing process for positioning bead spacers at intended positions with precision by using an ink jet method;

FIG. 6A is a plan view of a substrate 1 including two conventional TFT substrates for a liquid crystal display panel;

FIG. 6B is an enlarged detailed view of a portion A of the substrate of FIG. 6A;

FIG. 7 is a schematic cross-sectional view illustrating the layer structure of a TFT circuit of the inverted-staggered type;

FIG. 8A is a schematic plan view illustrating a case in which an angle between a direction of arrangement of ink-solution-discharge nozzles of an ink jet head and a direction of movement of an ink jet head or a substrate is 90 degrees;

FIG. 8B is a schematic plan view illustrating a method of varying a pitch of coating using one ink jet head by varying an angle between the direction of arrangement of ink-solution-discharge nozzles of an ink jet head and the direction of movement of the ink jet head or the substrate;

FIG. 9A is a plan view of a substrate 1 including two conventional CF substrates for liquid crystal display panels;

FIG. 9B is an enlarged detailed view of a portion A of the substrate of FIG. 9A;

FIG. 9C is a cross-sectional view of the CF substrate of FIG. 9B taken along line IXC-IXC of FIG. 9B;

FIG. 9D is a cross-sectional view of the CF substrate of FIG. 9B taken along line IXD-IXD of FIG. 9B;

FIG. 9E is a cross-sectional view of the CF substrate of FIG. 9B taken along line IXE-IXE of FIG. 9B;

FIG. 10A is a plan view of a substrate including two conventional CF substrates for liquid crystal display panels;

FIG. 10B is an enlarged detailed view of a portion A of the CF substrate of FIG. 10A;

FIG. 10C is a cross-sectional view of the CF substrate of FIG. 10B taken along line XC-XC of FIG. 10B;

FIG. 10D is a cross-sectional view of the CF substrate of FIG. 10B taken along line XD-XD of FIG. 10B;

FIG. 10E is a cross-sectional view of the CF substrate of FIG. 10B taken along line XE-XE of FIG. 10B;

FIG. 11A is a plan view of a substrate including two CF substrates in accordance with Embodiment 2 of the present invention;

FIG. 11B is an enlarged detailed view of a portion A of the CF substrate of FIG. 11A;

FIG. 11C is a cross-sectional view of the CF substrate of FIG. 11B taken along line XIC-XIC of FIG. 11B;

FIG. 11D is a cross-sectional view of the CF substrate of FIG. 11B taken along line XID-XID of FIG. 11B;

FIG. 11E is a cross-sectional view of the CF substrate of FIG. 11B taken along line XIE-XIE of FIG. 11B;

FIG. 12 is a cross-sectional view of a liquid crystal display panel fabricated by using the CF substrate in accordance with Embodiment 2 of the present invention;

FIG. 13A is a plan view of a substrate including two CF substrates for liquid crystal display panels in accordance with Embodiment 3 of the present invention;

FIG. 13B is an enlarged detailed view of a portion A of the CF substrate of FIG. 13A;

FIG. 13C is a cross-sectional view of the CF substrate of FIG. 13B taken along line XIIIC-XIIIC of FIG. 13B;

FIG. 13D is a cross-sectional view of the CF substrate of FIG. 13B taken along line XIIID-XIIID of FIG. 13B;

FIG. 13E is a cross-sectional view of the CF substrate of FIG. 13B taken along line XIIIE-XIIIE of FIG. 13B;

FIG. 14 is a cross-sectional view of a liquid crystal display panel fabricated by using the CF substrate in accordance with Embodiment 3 of the present invention;

FIG. 15A is a plan view of a substrate including two TFT substrates for liquid crystal display panels in accordance with Embodiment 4 of the present invention;

FIG. 15B is an enlarged detailed view of a portion A of the TFT substrate of FIG. 15A;

FIG. 15C is a cross-sectional view of the TFT substrate of FIG. 15B taken along line XVC-XVC of FIG. 15B; and

FIG. 16 is a cross-sectional view of a liquid crystal display panel fabricated by using the TFT substrate in accordance with Embodiment 4 of the present invention.

### DETAILED DESCRIPTION OF THE PREFERRED EMBODIMENTS

The embodiments in accordance with the present invention will be explained in detail by reference to the drawings. The same reference numerals or symbols designate functionally similar components or portions throughout the figures for explaining the embodiments, and repetition of their explanation is omitted. Dimensions of certain of the components or portions are exaggerated for clarity.

### Embodiment 1

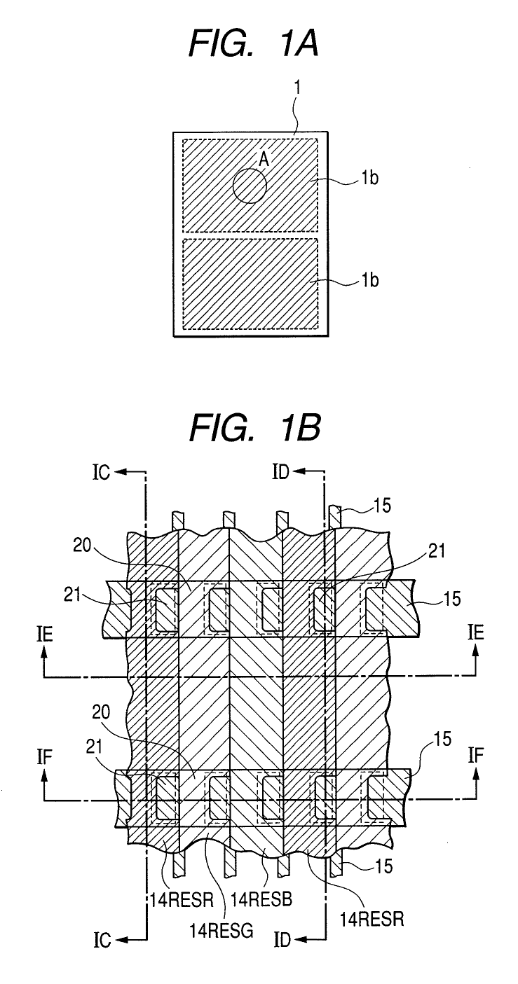

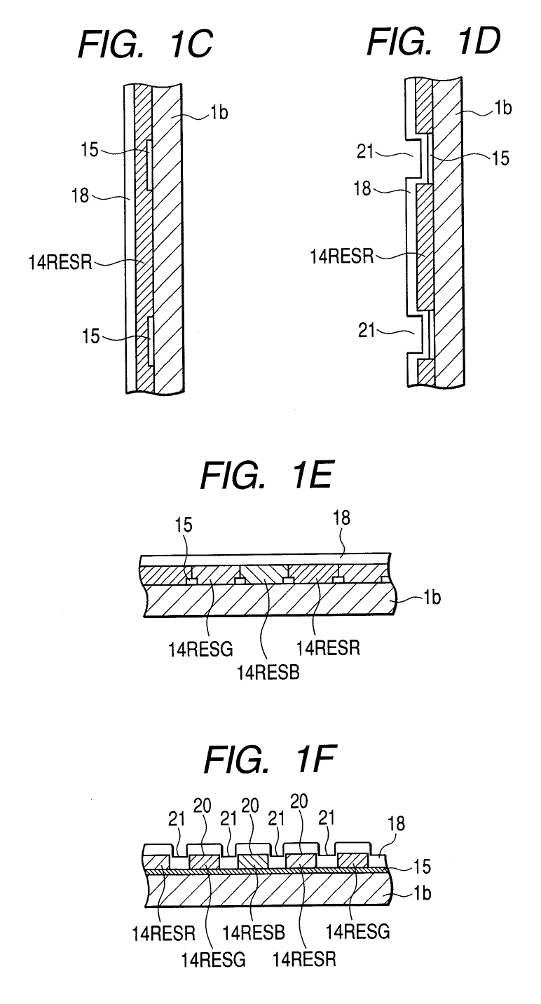

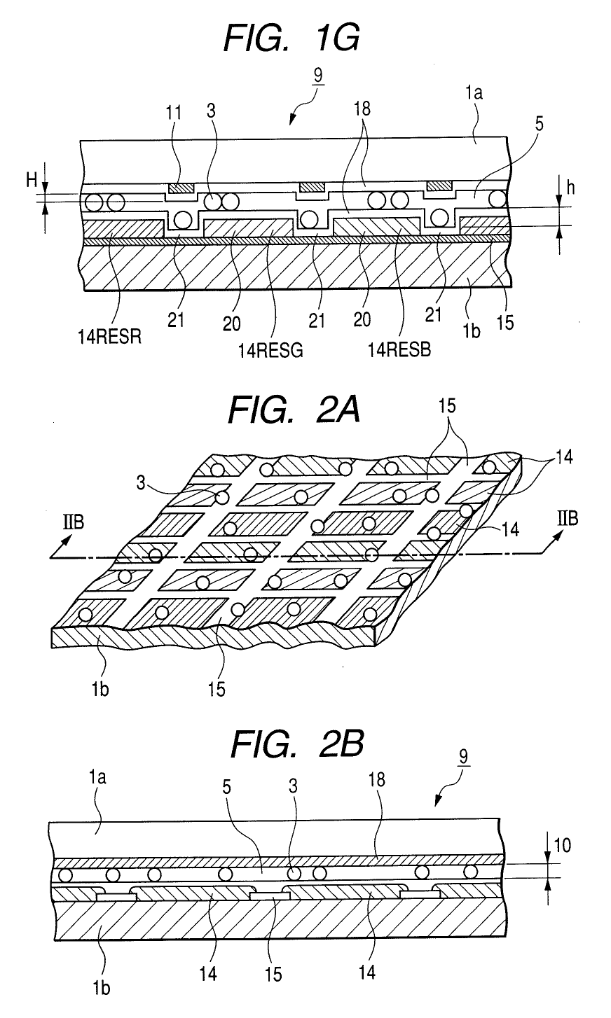

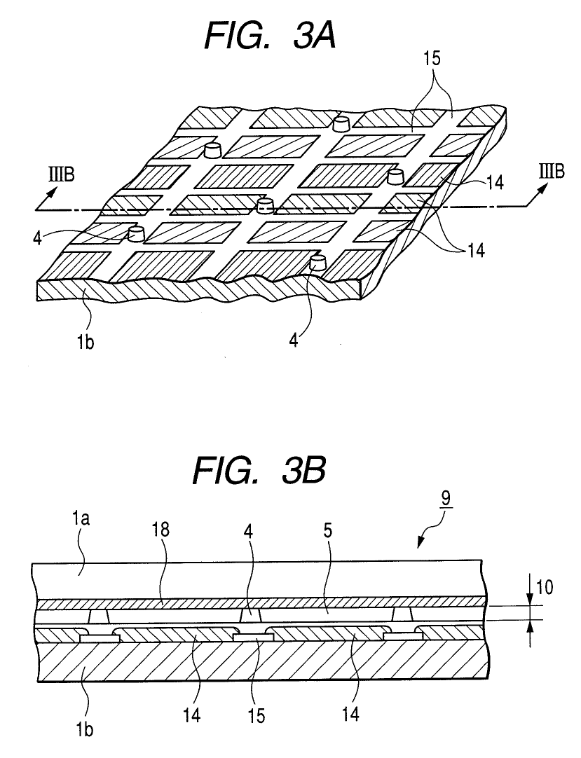

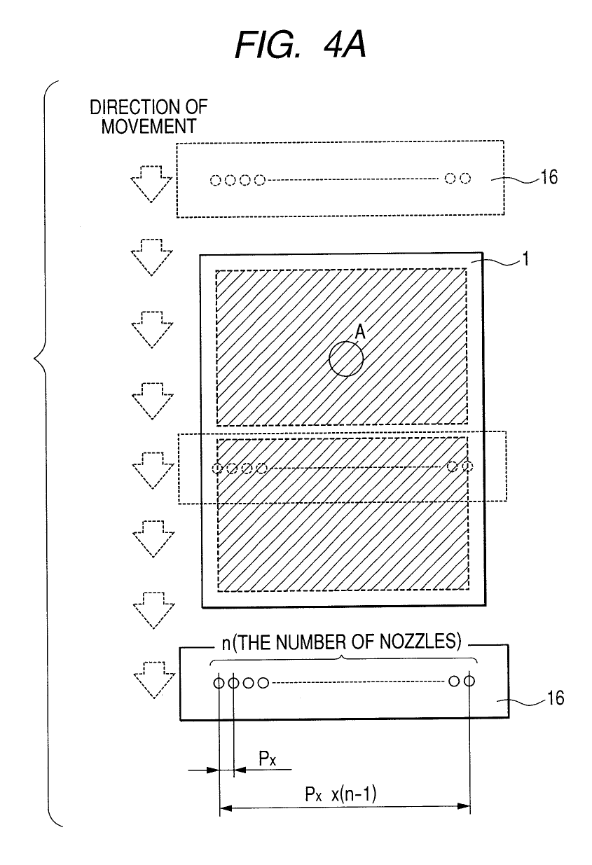

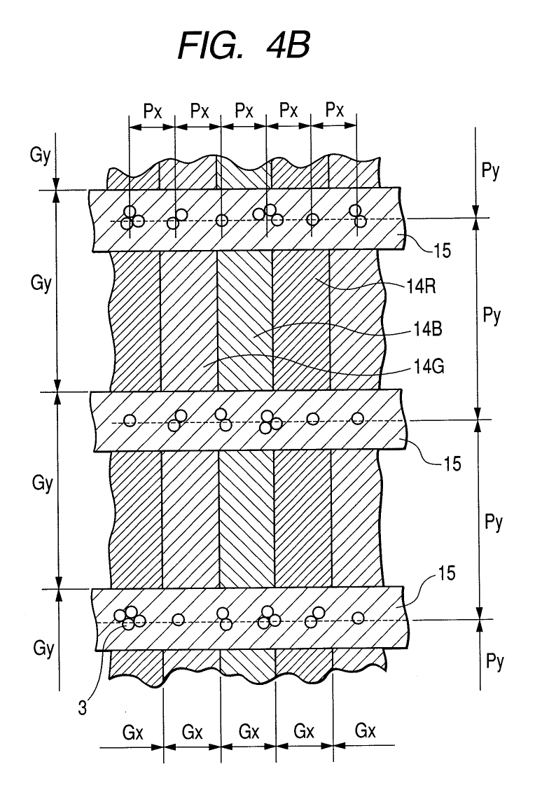

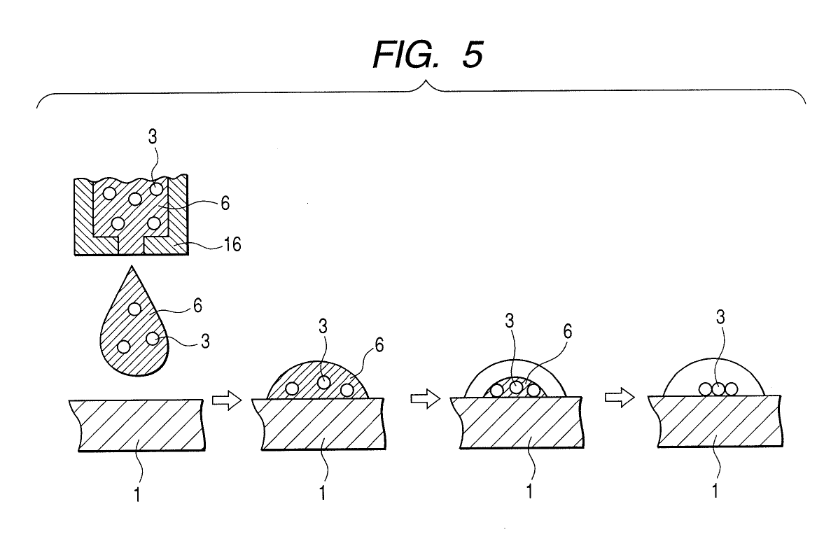

Embodiment 1 will be explained by reference to FIGS. 1A to 1F, 6A to 6B, 9A to 9E and 10A to 10E.

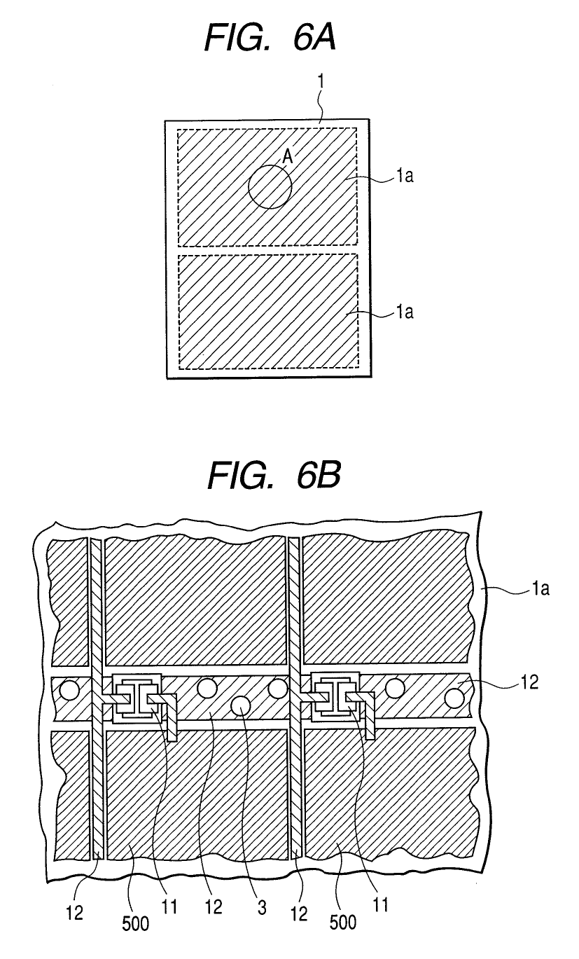

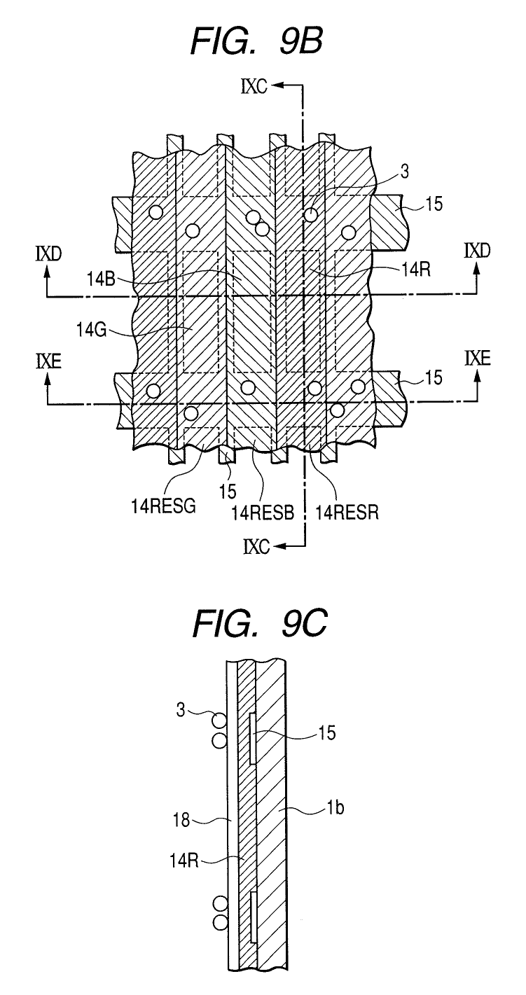

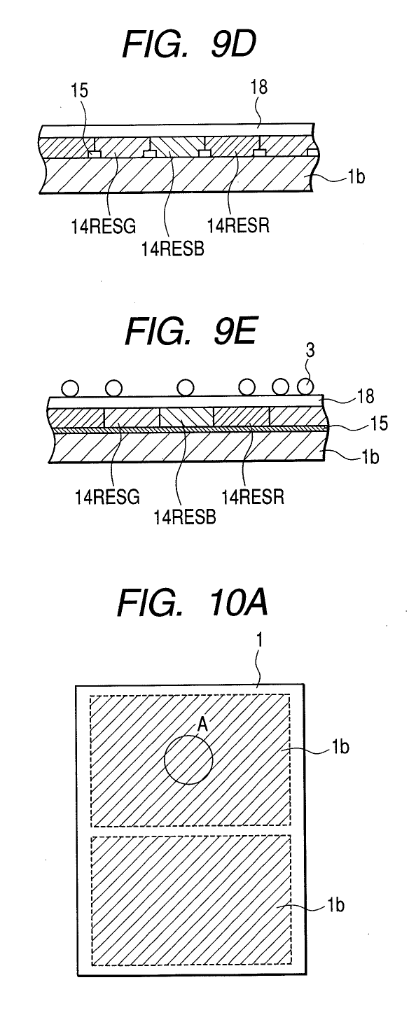

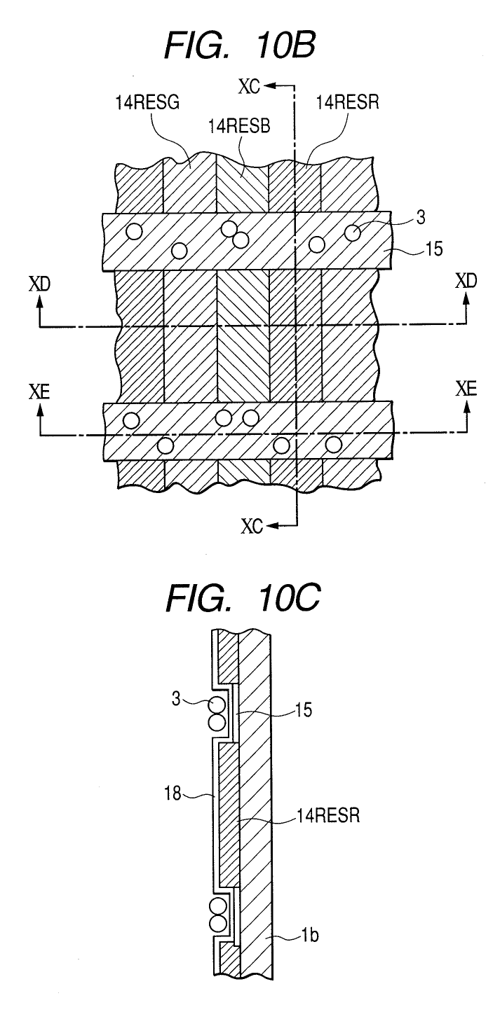

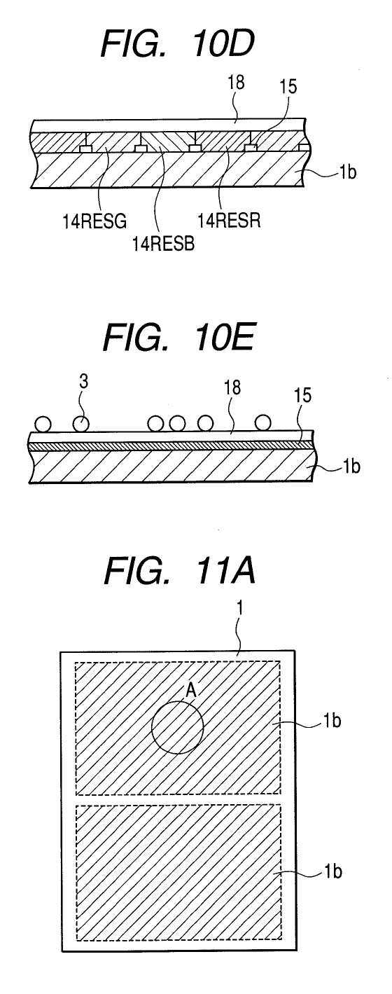

FIG. 6A is a plan view of a substrate 1 including two conventional TFT substrates 1a for a liquid crystal display panel, and FIG. 6B is an enlarged detailed view of a portion A of FIG. 6A. FIG. 9A is a plan view of a substrate 1 including two conventional CF substrates 1b for the liquid crystal display panel, FIG. 9B is an enlarged detailed view of a portion A of FIG. 9A, FIG. 9C is a cross-sectional view of the CF substrate 1b of FIG. 9B taken along line IXC-IXC of FIG. 9B, FIG. 9D is a cross-sectional view of the CF substrate 1b of FIG. 9B taken along line IXD-IXD of FIG. 9B, and FIG. 9E is a cross-sectional view of the CF substrate 1b of FIG. 9B taken along line IXE-IXE of FIG. 9B. Further, FIG. 10A is a plan view of a substrate 1 including two conventional CF substrates 1b for the liquid crystal display panel, FIG. 10B is an enlarged detailed view of a portion A of FIG. 10A, FIG. 10C is a cross-sectional view of the CF substrate 1b of FIG. 10B taken along line XC-XC of FIG. 10B, FIG. 10D is a cross-sectional view of the CF substrate 1b of FIG. 10B taken along line XD-XD of FIG. 10B, and FIG. 10E is a cross-sectional view of the CF substrate 1b of FIG. 10B taken along line XE-XE of FIG. 10B. Reference numeral 18 in FIGS. 9C to 9E and 10C to 10E denotes an overcoat (OC) film made of acrylic resin, for example.

In a case in which bead spacers (known, for example, as spherical spacers formed of resin) 3 are used as spacers for maintaining a spacing between the TFT substrate 1a and the CF substrate 1b at a constant value, there is a requirement that the bead spacers 3 be disposed in regions between R (red) sub-pixels 14R, G (green) sub-pixels 14G and B (blue) sub-pixels 14B which do not affect display quality of the liquid crystal display panel as shown in FIGS. 6B, 9B to 9E and 10B to 10E, and more specifically, when the TFT substrate 1a is considered, the bead spacers 3 need to be positioned on interconnection line patterns where the pixel circuits 11 and electrode lines 12 are formed, and when the CF substrate 1b is considered, the bead spacers 3 need to be positioned on the patterns of the BM (Black Matrix) 15.

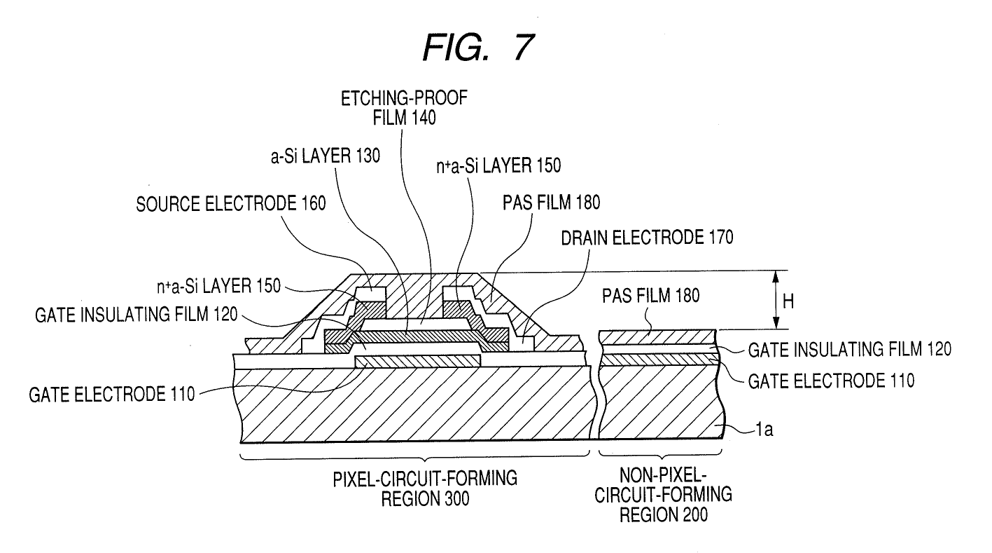

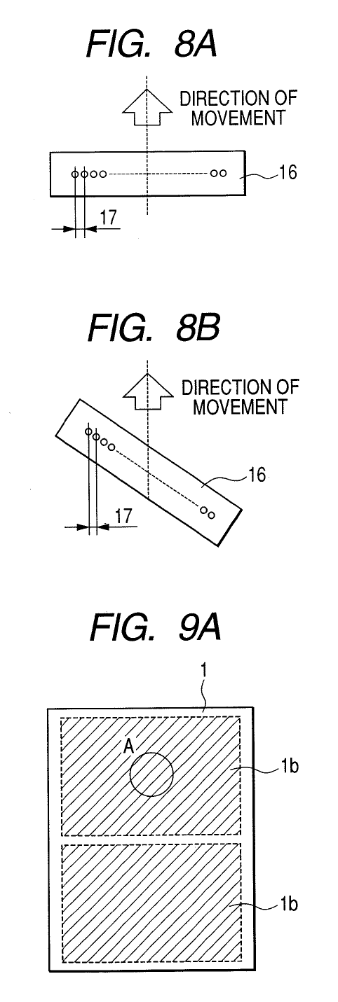

It is to be noted that the pixel circuits 11 for driving and controlling the sub-pixels are disposed on the interconnection lines of the TFT substrate 1a. As explained previously, by way of example, FIG. 7 illustrates the structure of the a-Si (Amorphous-Silicon) TFT of the inverted-staggered type widely used as the pixel circuits 11 of the liquid crystal display panel.

As shown in FIG. 7, since the a-Si TFT of the inverted-staggered type is formed by stacking electrode lines and insulating films, there is a difference H between the height of a pixel-circuit-forming region 300 with respect to the surface of the glass substrate and the height of a non-pixel-circuit-forming region 200 formed of the electrode lines 12 only and not having the pixel circuits 11 therein. Therefore, if some of the bead spacers 3 are disposed in the pixel-circuit-forming region 300, the difference H is caused between the height of the spacers 3 disposed in the pixel-circuit-forming region 300 and the height of the spacers 3 disposed in regions other than the pixel-circuit-forming region 300. Consequently, in the assembled liquid crystal display panels, variations occur in the cell gap, which is the spacing between the TFT substrate 1a and the CF substrate 1b, and these variations in the cell gap produce defective displays of the liquid crystal display panels. Further, if excessive forces are exerted on the pixel circuits 11 on the TFT substrate 1a via the bead spacers 3, there has been fears that characteristics of the pixel circuits 11 are changed, and that in the worst case the pixel circuits 11 are destroyed, sub-pixels 14 to be controlled by the destroyed pixel circuits 11 become uncontrollable and display undesired bright spots or undesired black spots, resulting in deterioration of quality of the liquid crystal display panels themselves.

For the purpose of solving problems occurring in the assembling of liquid crystal display panels, the present invention configures the TFT substrate 1a and the CF substrate 1b disposed to face the TFT substrate 1a as described below. In the following, the present invention will be explained in detail.

Usually the CF substrate 1b is configured such that the sub-pixels 14R, the sub-pixels 14G and the sub-pixels 14B are separated from each other by the BM 15 as shown in FIGS. 9B to 9E and 10B to 10E, for the purpose of improving display contrast ratio, preventing the mixture of different colors of adjacent color resists which form color filters, and blocking the passage of light through the regions (non-driving-circuit sections) formed with interconnection lines on the TFT substrate 1a.

The configuration of the CF substrate 1b may depend upon the kind of liquid crystal display panels. In one case, red resists 14RESR, green resists 14RESG and blue resists 14RESB corresponding to red, green and blue filters, respectively, are coated on the BM 15 also, as shown in FIGS. 9B to 9E. On the other hand, in another case, the red resists 14RESR, the green resists 14RESG or the blue resists 14RESB are not coated on the BM 15, as shown in FIGS. 10B to 10E.

Greater detail of color resists is contained in U.S. Pat. Nos. 6,136,481, 6,190,489 B1 and 6,270,576B1, the disclosures of which are herein incorporated by reference.

In a case in which a liquid crystal display panel is fabricated by using the TFT substrate 1a and the CF substrate 1b, the pixel circuits 11 and the regions containing interconnection lines on the TFT substrate 1a are disposed to face the BM 15 regions on the CF substrate 1b.

The following will explain the present invention based upon the above relationship in arrangement between the TFT substrate 1a and the CF substrate 1b.

FIG. 1A is a plan view of a substrate 1 including two CF substrates 1b for liquid crystal display panels in accordance with an embodiment of the present invention, FIG. 1B is an enlarged detailed view of a portion A of FIG. 1A, FIG. 1C is a cross-sectional view of the CF substrate 1b of FIG. 1B taken along line IC-IC of FIG. 1B, FIG. 1D is a cross-sectional view of the CF substrate 1b of FIG. 1B taken along line ID-ID of FIG. 1B, FIG. 1E is a cross-sectional view of the CF substrate 1b of FIG. 1B taken along line IE-IE of FIG. 1B, and FIG. 1F is a cross-sectional view of the CF substrate 1b of FIG. 1B taken along line IF-IF of FIG. 1B. Reference numeral 18 in FIGS. 1C to 1F denotes an overcoat (OC) film made of acrylic resin, for example.

As shown in FIGS. 1B to 1G, this Embodiment produces steps having a step height h on surfaces on which surfaces the bead spacers are to be disposed, by intentionally dividing regions overlying the BM 15 on the CF substrate 1b into two kinds of regions; one of the two kinds of the regions is regions 20 on which the color resists 14RESR, 14RESG or 14RESB are coated, and the other of the two kinds of the regions is regions 21 on which the color resists 14RESR, 14RESG or 14RESB are not coated.

More specifically, the regions 21 on the CF substrate 1b where the color resists 14RESR, 14RESG or 14RESB are not coated on the BM 15 are configured to face the pixel circuits 11 fabricated on the TFT substrate 1a, and on the other hand, the regions 20 on the CF substrate 1b where the color resists 14RESR, 14RESG or 14RESB are coated on the BM 15 are configured to face regions of the TFT substrate 1a where the pixel circuits are not fabricated, and where only interconnection lines are disposed.

As shown in FIG. 1B, in the regions 21 on the CF substrate 1b which face the pixel circuits 11 on the TFT substrate 1a, the color resists 14RESR, 14RESG and 14RESB are formed with openings or cuts therein, and in the regions 20 on the CF substrate 1b which face the regions of the TFT substrate 1a where only the interconnection lines are disposed, the color resists 14RESR, 14RESG and 14RESB are formed solid all over the BM.

In FIG. 1B, illustrated as the regions 21 not coated with color resists are cuts adjacent to edges of color resists 14RESR, 14RESG and 14RESB, respectively, but openings (indicated in broken lines) not adjacent to the edges of the color resists 14RESR, 14RESG and 14RESB, respectively, may be provided instead of the cuts.

The above-mentioned height h of the steps is determined by the thickness of the color resist films 14RESR, 14RESG, 14RESB+the thickness of the overcoat (hereinafter OC) film 18−the thickness of the OC film 18. Depending upon product specifications, in the same CF substrate 1b for the liquid crystal display panels, red, green and blue color resists 14RESR, 14RESG and 14RESB may not be equal in thickness to each other in some cases. In these cases, the heights hR, hG, hB of the steps for red, green and blue sub-pixels are represented by the following:
hR=(the thickness of a red color resist film+the thickness of the OC film 18)−the thickness of the OC film 18;
hG=(the thickness of a green color resist film+the thickness of the OC film 18)−the thickness of the OC film 18;
hB=(the thickness of a blue color resist film+the thickness of the OC film 18)−the thickness of the OC film 18.

In these cases, the minimum of hR, hG and hB is a basis of the required height h of the steps.

FIG. 1G is a cross-sectional view of the liquid crystal display panel 9 fabricated by using the CF substrate 1b in accordance with this Embodiment. Since the patterns of the color resists 14RESR, 14RESG and 14RESB on the CF substrate 1b are provided with openings or cuts, the step height h is produced between the above-explained regions 20 and 21 on the CF substrate 1b. On the other hand, in the case of the TFT substrate 1a, as illustrated in FIGS. 1G and 7, H denotes a height of a step between the regions where the pixel circuits 11 is disposed and the regions where only the interconnection lines are disposed.

As illustrated in FIG. 1G, even in a case in which some of the bead spacers 3 are disposed in the regions where the pixel circuits 11 are disposed by chance, the patterns of the color resists 14RESR, 14RESG and 14RESB on the CF substrate 1b are provided with openings or cuts facing the pixel circuits 11, therefore the step height h greater than the step height H is produced between the above-explained regions 20 and 21 on the CF substrate 1b, and therefore the bead spacers 3 do not exert excessive forces on the pixel circuits 11. Consequently, this embodiment is capable of suppressing occurrences of defective displays due to variations in cell gap or destruction of the pixel circuits 11, which have been causing problems. Therefore the present invention is capable of suppressing the occurrences of defective displays of the liquid crystal display panels without selecting the pitch Px of ink-solution-discharge nozzles of an ink jet head to be equal to the pitch Gx of the sub-pixels.

### Embodiment 2

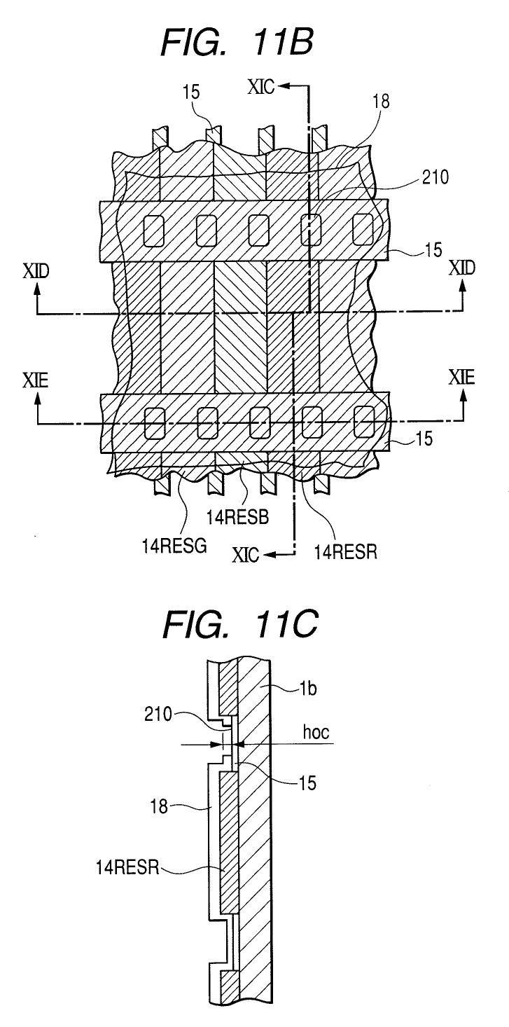

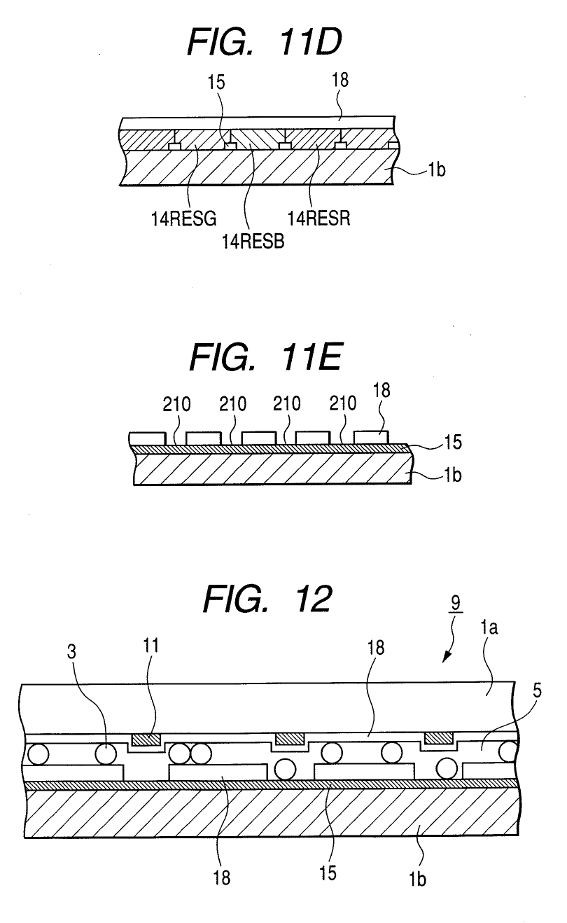

Embodiment 2 will be explained by reference to FIGS. 11A to 11E and 12. FIG. 11A is a plan view of a substrate 1 including two CF substrates 1b for liquid crystal display panels in accordance with Embodiment 2 of the present invention, FIG. 11B is an enlarged detailed view of a portion A of FIG. 11A. FIG. 11C is a cross-sectional view of the CF substrate 1b of FIG. 11B taken along line XIC-XIC of FIG. 11B, FIG. 11D is a cross-sectional view of the CF substrate 1b of FIG. 11B taken along line XID-XID of FIG. 11B, and FIG. 11E is a cross-sectional view of the CF substrate 1b of FIG. 11B taken along line XIE-XIE of FIG. 11B. Reference numeral 18 in FIGS. 11C to 11E denotes an overcoat (OC) film made of acrylic resin, for example. FIG. 12 is a cross-sectional view of the liquid crystal display panel 9 fabricated by using the CF substrate 1b in accordance with this Embodiment 2.

The above-described Embodiment 1 is configured such that the CF substrate 1b is formed with steps having a step height equal to or greater than the step height formed on the TFT substrate 1a by the pixel circuits 11, by forming openings or cuts in patterns of color resists disposed on the BM 15.

On the other hand, Embodiment 2 does not produce the steps by using the patterns of color resists, but produce the steps by patterning of the OC (Overcoat) film 18. In Embodiment 2, the CF substrate 1b is provided thereon with steps having a step height hoc (which is equal to the thickness of the OC film 18) equal to or greater than the step height produced on the TFT substrate 1a by the pixel circuits 11. The OC film 18 is usually coated on a top layer of the stacked layers on the CF substrate 1b, and the OC film 18 is patterned such that some regions of the surface of the CF substrate 1b are coated with the OC film 18, and that other regions of the surface of the CF substrate 1b are not coated with the OC film 18, and consequently, the step height hoc equal to the thickness of the OC film 18 is produced between the regions coated with the OC film 18 and the regions not coated with the OC film 18.

In many cases, the OC film 18 is coated on the CF substrate 1b after the BM 15 and the R, G and B color resists 14RESR, 14RESG and 14RESB are coated on the CF substrate 1b, for the purpose of preventing the R, G and B color resists from affecting the liquid crystal material, preventing a rubbing treatment from affecting the R, G and B color resists, and planarizing the structures on the CF substrate 1b. Usually the OC film 18 is coated solidly over the entire surface of the CF substrate 1b.

In this Embodiment 2, the CF substrate 1b is provided thereon with steps having the step height hoc equal to or greater than the step height H produced on the TFT substrate 1a by the pixel circuits 11. As shown in FIGS. 11B, 11C and 11E, the step height hoc is produced by providing OC-film-free regions 210 in the form of an opening fabricated by omitting of coating operation of the OC film 18 in regions of the CF substrate 1b which are intended to face the pixel circuits 11 on the TFT substrate 1a in a state in which the CF substrate 1b and the TFT substrate 1a have been assembled together, or providing OC-film-free regions 210 in the form of an opening fabricated by initially coating the OC film 18 solidly over the entire surface of the CF substrate 1b, then removing the OC film 18 lying in regions of the CF substrate 1b which are intended to face the pixel circuits 11 on the TFT substrate 1a in the state in which the CF substrate 1b and the TFT substrate 1a have been assembled together. FIG. 12 is a cross-sectional view of the liquid crystal display panel 9 fabricated by using the CF substrate 1b in accordance with this Embodiment 2.

### Embodiment 3

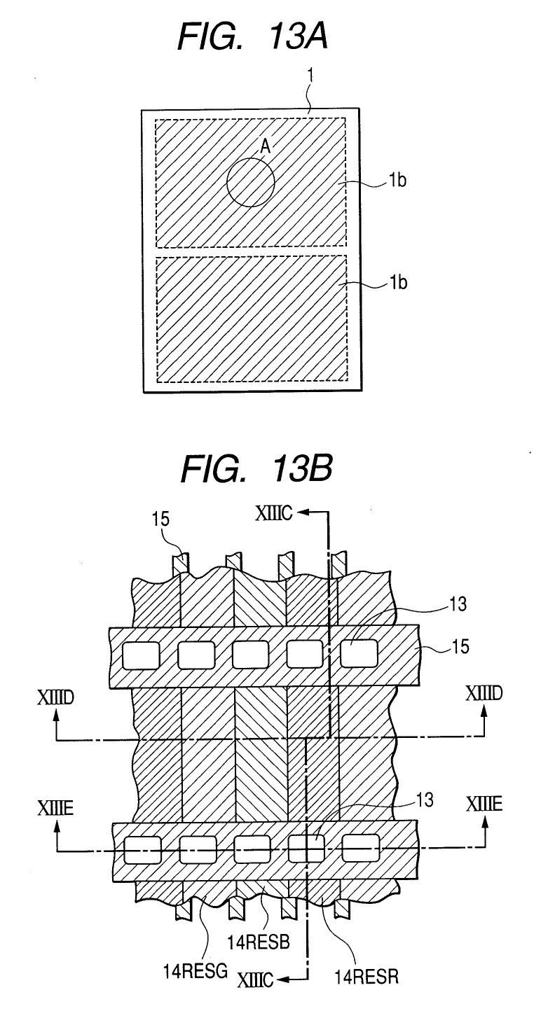

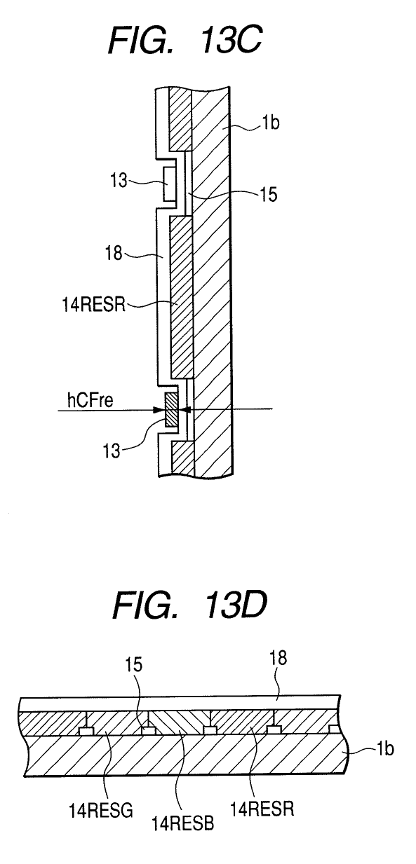

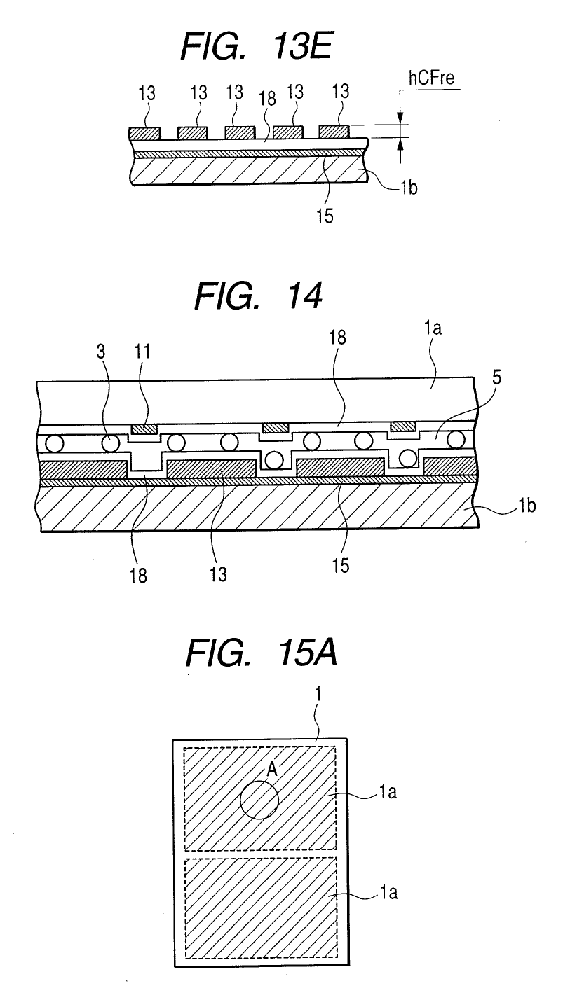

Embodiment 3 will be explained by reference to FIGS. 13A to 13E and 14. FIG. 13A is a plan view of a substrate 1 including two CF substrates 1b for liquid crystal display panels in accordance with Embodiment 3 of the present invention, FIG. 13B is an enlarged detailed view of a portion A of FIG. 13A. FIG. 13C is a cross-sectional view of the CF substrate 1b of FIG. 13B taken along line XIIIC-XIIIC of FIG. 13B, FIG. 13D is a cross-sectional view of the CF substrate 1b of FIG. 13B taken along line XIIID-XIIID of FIG. 13B, and FIG. 13E is a cross-sectional view of the CF substrate 1b of FIG. 13B taken along line XIIIE-XIIIE of FIG. 13B. Reference numeral 18 in FIGS. 13C to 13E denotes an overcoat (OC) film made of acrylic resin, for example. FIG. 14 is a cross-sectional view of the liquid crystal display panel 9 fabricated by using the CF substrate 1b in accordance with this Embodiment 3.

Embodiment 3 produces steps on the CF substrate 1b as in the cases of Embodiments 1 and 2. Embodiment 3 produces the steps on the CF substrate 1b by forming pedestals (for example, formed of layers underlying the bead spacers 3) 13 by coating photoresist material on regions of the BM 15 which are intended not to face the pixel circuits 11 on the TFT substrate 1a in a state in which the CF substrate 1b and the TFT substrate 1a have been assembled together. By way of example, by using as a material for the pedestals 13 an ultraviolet-curable photoresist material which are used as a material for photospacers, the pedestals 13 are fabricated by coating the ultraviolet-curable photoresist material on regions of the BM 15 which are intended not to face the pixel circuits 11 and which are intended to face interconnection lines on the TFT substrate 1a in the state in which the CF substrate 1b and the TFT substrate 1a have been assembled together. The height hCFre of the pedestals 13 is selected to be greater than the height H of a step between the pixel-circuit-forming region 300 where the pixel circuit 11 is formed and the non-pixel-circuit-forming region 200 where only the electrode line 12 is formed. When the CF substrate 1b of the above-explained configuration is employed, even if some of the bead spacers 3 are deposited on the pixel circuits 11 by any chance, excessive forces are not exerted on the pixel circuits 11 by the bead spacers 3, because the steps are provided on the CF substrate 1b opposing the TFT substrate 1a. Consequently, Embodiment 3 provides the advantage that the occurrences of defective displays can be suppressed which are caused by the problems of variations in cell gap or destruction of the pixel circuits 11.

### Embodiment 4

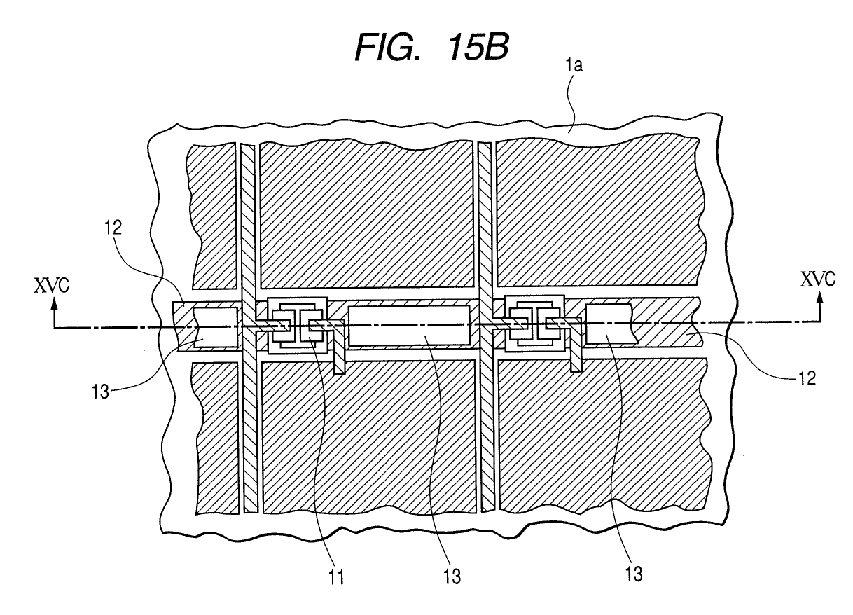

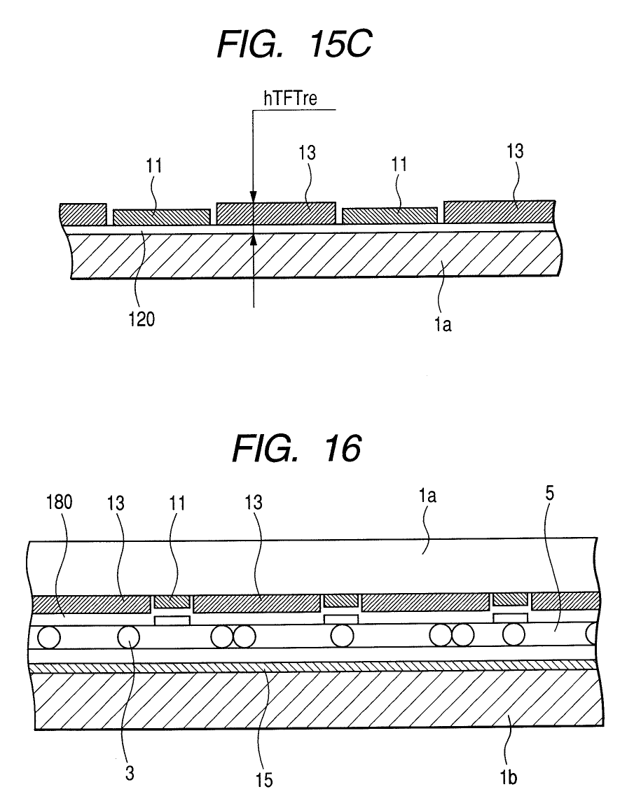

Embodiment 4 will be explained by reference to FIGS. 15A to 15C and 16. FIG. 15A is a plan view of a substrate 1 including two TFT substrates 1a for liquid crystal display panels in accordance with Embodiment 4 of the present invention, FIG. 15B is an enlarged detailed view of a portion A of FIG. 15A. FIG. 15C is a cross-sectional view of the TFT substrate 1a of FIG. 15B taken along line XVC-XVC of FIG. 15B, and FIG. 16 is a cross-sectional view of the liquid crystal display panel 9 fabricated by using the TFT substrate 1a in accordance with this Embodiment 4.

The above-explained Embodiment 3 is configured such that the steps are produced between regions of the CF substrate 1b which face the pixel circuits 11 on the TFT substrate 1a and regions of the CF substrate 1b which face regions of the TFT substrate 1a formed with electrode lines 12 only, by using a photoresist material. In this Embodiment 4, as shown in FIG. 15B, pedestals 13 are provided on regions of the TFT substrate 1a having formed thereon the electrode lines 12 only and not having formed thereon the pixel circuits 11.

More specifically, using as a material for the pedestals 13 an ultraviolet-curable photoresist material which are used as a material for photospacers, the pedestals 13 are fabricated by coating the ultraviolet-curable photoresist material on regions of the TFT substrate 1a formed thereon with the electrode lines 12 only and not formed thereon with the pixel circuits 11.

The height hTFTre of the pedestals 13 is required to selected to be greater than the height H of the step between the pixel-circuit-forming region 300 and the non-pixel-circuit-forming region 200 of the TFT substrate 1a shown in FIG. 7. When the TFT substrate 1a of the above-explained configuration is employed as shown in FIG. 16, even if some of the bead spacers 3 are deposited on the pixel circuits 11 by any chance, excessive forces are not exerted on the pixel circuits 11 by the bead spacers 3, because the top surface of the pedestals 13 are configured so as to be higher than that of the pixel circuits 11. Consequently, this Embodiment 4 provides the advantage that the occurrences of defective displays can be suppressed which are caused by the problems of variations in cell gap or destruction of the pixel circuits 11.

For the purpose of preventing the occurrences of defective displays, basically it is necessary that the above-explained step heights h, hoc and the above-explained heights hCFre, hTFTre of the pedestals 13 are selected to be greater than the step height H between the regions of the driving circuits 11 and the regions of the electrode lines 12 of the TFT substrate 1a as expressed below.
h>H;
hoc>H;
hCFre>H;
hTFTre>H.

The present inventors have experimentally confirmed that in a case where bead spacers made of a high polymer material having a compressive modulus of about 0.5 N/mm² is employed, even when the above-explained step heights h, hoc and above-explained pedestal heights hCFre, hTFTre may be selected to be about 10% smaller than the above-explained step height H, no problems with display quality arise.

What is claimed is:

1. A liquid crystal display panel comprising:
a pair of substrates;
a liquid crystal material sandwiched between said pair of substrates;
a plurality of pixel electrodes disposed in a matrix on an inner surface of one of said pair of substrates;
a plurality of pixel circuits, each of said plurality of pixel circuits being disposed in a vicinity of a corresponding one of said plurality of pixel electrodes and driving said corresponding one of said plurality of pixel electrodes;
a plurality of video signal lines disposed on said inner surface of said one of said pair of substrates and supplying video signals to said plurality of pixel circuits;
a plurality of control signal lines disposed on said inner surface of said one of said pair of substrates and supplying control signals to said plurality of pixel circuits;
a plurality of color resists disposed on an inner surface of another of said pair of substrates and constituting primary-color filters each associated with a corresponding one of said plurality of pixel electrodes;
a black matrix comprised of a light-blocking material, disposed on said inner surface of said another of said pair of substrates, and defining an area useful for display of each of said plurality of color resists; and
a plurality of bead spacers disposed between said pair of substrates and establishing a spacing between said pair of substrates,
wherein:
said plurality of pixel circuits, said plurality of video signal lines and said plurality of control signal lines are disposed to face said black matrix;
said plurality of bead spacers are disposed to face said black matrix; and
openings or cuts are provided in portions of regions of said plurality of color resists overlapping said black matrix and facing said plurality of pixel circuits.

2. The liquid crystal display panel according to claim 1, wherein, in regions of said inner surface of said one of said pair of substrates facing said plurality of bead spacers, a height h of a step produced by said openings or cuts is greater than a height H of a step produced by said plurality of pixel circuits with respect to regions where said plurality of video signal lines or said plurality of control signal lines are disposed.

3. A liquid crystal display panel comprising:
a pair of substrates;
a liquid crystal material sandwiched between said pair of substrates;
a plurality of pixel electrodes disposed in a matrix on an inner surface of one of said pair of substrates;
a plurality of pixel circuits, each of said plurality of pixel circuits being disposed in a vicinity of a corresponding one of said plurality of pixel electrodes and driving said corresponding one of said plurality of pixel electrodes;
a plurality of video signal lines disposed on said inner surface of said one of said pair of substrates and supplying video signals to said plurality of pixel circuits;
a plurality of control signal lines disposed on said inner surface of said one of said pair of substrates and supplying control signals to said plurality of pixel circuits;
a plurality of color filters disposed on an inner surface of another of said pair of substrates and each associated with a corresponding one of said plurality of pixel electrodes;
a black matrix comprised of a light-blocking material, disposed on said inner surface of said another of said pair of substrates, and defining an area useful for display of each of said plurality of color filers;
an overcoat film covering said plurality of color filters; and
a plurality of bead spacers disposed between said pair of substrates and establishing a spacing between said pair of substrates,
wherein:
said plurality of pixel circuits, said plurality of video signal lines and said plurality of control signal lines are disposed to face said black matrix;
said plurality of bead spacers are disposed to face said black matrix; and
openings are provided in regions of said overcoat film facing said plurality of pixel circuits.

4. The liquid crystal display panel according to claim 3, wherein, in regions of said inner surface of said one of said pair of substrates facing said plurality of bead spacers, a height hoc of a step produced by said openings in said overcoat film is greater than a height H of a step produced by said plurality of pixel circuits with respect to regions where said plurality of video signal lines or said plurality of control signal lines are disposed.

5. A liquid crystal display panel comprising:
a pair of substrates;
a liquid crystal material sandwiched between said pair of substrates;
a plurality of pixel electrodes disposed in a matrix on an inner surface of one of said pair of substrates;
a plurality of pixel circuits, each of said plurality of pixel circuits being disposed in a vicinity of a corresponding one of said plurality of pixel electrodes and driving said corresponding one of said plurality of pixel electrodes;
a plurality of video signal lines disposed on said inner surface of said one of said pair of substrates and supplying video signals to said plurality of pixel circuits;
a plurality of control signal lines disposed on said inner surface of said one of said pair of substrates and supplying control signals to said plurality of pixel circuits;
a plurality of color filters disposed on an inner surface of another of said pair of substrates and each associated with a corresponding one of said plurality of pixel electrodes;
a black matrix comprised of a light-blocking material, disposed on said inner surface of said another of said pair of substrates, and defining an area useful for display of each of said plurality of color filers; and
a plurality of bead spacers disposed between said pair of substrates and establishing a spacing between said pair of substrates,
wherein:
said plurality of pixel circuits, said plurality of video signal lines and said plurality of control signal lines are disposed to face said black matrix;
said plurality of bead spacers are disposed to face said black matrix; and
pedestals are provided in regions of said inner surface of said another of said pair of substrates which face said plurality of bead spacers, and which do not face said plurality of pixel circuits.

6. The liquid crystal display panel according to claim 5, wherein a height of said pedestals is greater than a height H of a step produced by said plurality of pixel circuits in regions of said inner surface of said one of said pair of substrates facing said plurality of bead spacers, said height H being measured with respect to regions where said plurality of video signal lines or said plurality of control signal lines are disposed.

7. A liquid crystal display panel comprising:
a pair of substrates;
a liquid crystal material sandwiched between said pair of substrates;
a plurality of pixel electrodes disposed in a matrix on an inner surface of one of said pair of substrates;
a plurality of pixel circuits, each of said plurality of pixel circuits being disposed in a vicinity of a corresponding one of said plurality of pixel electrodes and driving said corresponding one of said plurality of pixel electrodes;
a plurality of video signal lines disposed on said inner surface of said one of said pair of substrates and supplying video signals to said plurality of pixel circuits;
a plurality of control signal lines disposed on said inner surface of said one of said pair of substrates and supplying control signals to said plurality of pixel circuits;
a plurality of color filters disposed on an inner surface of another of said pair of substrates and each associated with a corresponding one of said plurality of pixel electrodes;
a black matrix comprised of a light-blocking material, disposed on said inner surface of said another of said pair of substrates, and defining an area useful for display of each of said plurality of color filers; and
a plurality of bead spacers disposed between said pair of substrates and establishing a spacing between said pair of substrates,
wherein:
said plurality of pixel circuits, said plurality of video signal lines and said plurality of control signal lines are disposed to face said black matrix;
said plurality of bead spacers are disposed to face said black matrix; and
pedestals are provided in regions of said inner surface of said another of said pair of substrates which face said plurality of bead spacers, and in which said plurality of pixel circuits are not disposed.

8. The liquid crystal display panel according to claim 7, wherein a height of said pedestals is greater than a height H of a step produced by said plurality of pixel circuits in regions of said inner surface of said one of said pair of substrates facing said plurality of bead spacers, said height H being measured with respect to regions where said plurality of video signal lines or said plurality of control signal lines are disposed.
